(19) United States
(12) Patent Application Publication
(10) Pub. No.: US 2018/0253744 A1
(43) Pub. Date: Sep. 6, 2018

(54) COLLABORATIVE AND CONTENT BASED FILTERING

(71) Applicant: Rev 650, LLC dba StreamPage, Bountiful, UT (US)

(72) Inventor: Jon Schmitt, Bountiful, UT (US)

(21) Appl. No.: 15/948,854

(22) Filed: Apr. 9, 2018

Related U.S. Application Data
(60) Provisional application No. 62/456,024, filed on Feb. 7, 2017.

(51) Int. Cl. G06Q 30/02

(52) U.S. Cl. CPC G06Q 30/0204; G06Q 30/0258; G06Q 30/0201

(57) ABSTRACT

The system and method of providing user specific or subscriber specific content that is not only content specific but also subscriber specific. The system may group individual subscribers into persona groups wherein similar profile characteristics may align individual subscribers into these persona groups. Content may be provided to these persona groups and these persona groups may provide feedback to content creators/authors to edit such content specific for those persona groups. Distributors may also manage what content is provided to subscriber persona groups and allow distributors to automatically or manually manage what content is pushed to those persona groups.

### CROSS-REFERENCE TO RELATED APPLICATIONS

This application claims priority to U.S. Provisional Patent Application No. 62/456,024 entitled COLLABORATIVE AND CONTENT BASED FILTERING filed Feb. 7, 2017, which is incorporated herein by reference in its entirety.

### TECHNICAL FIELD

This disclosure relates generally to automating consumer based content and, more specifically, to the creation and maintenance of business to business content and business to consumer based content from authors, content creators, distributors and consumers. The system may easily and automatically provide consumer based content filtering based on predictive feedback of the program within a computer, tablet, smart phone or the like.

### BACKGROUND

Currently there are a number of programs that utilize the Internet search history of a user to provide a user with a desired advertisement. Many of these programs are run through a computer readable medium that marks the webpages and websites that a user visits and then based on those visits provides content to the user on his or her computer device, such as a smartphone, a computer (or laptop) a tablet or the like.

Content based information is easily obtained by consumers or subscribers and is continually being created by authors or creators and may be provided directly by those authors or creators or it may be forwarded to the consumers by a distributor. Then that content must be searched out by the consumers by visiting those creator's websites or by visiting those distributors of the content and often the content is shared on social media websites, text, printed mail, via email, etc. Often times that content is updated and revised but many consumers do not see this revisions or versioning. Likewise, the content may not be directly on point with a consumer's desires, wishes or requests. Further, many times subscribers experience fatigue from receiving too much information or irrelevant information that causes a consumer of subscriber to “unsubscribe” from notification lists.

The limitations of the current dissemination systems and methods along with the ability to access the content and filter that content for a subscriber have proved to be too much for content subscribers and much of the content is either not received by the right consumer or it is not on point with the desired information. The present system and method overcomes or reduces many of these limitations of current content creation, versioning and filtering.

### SUMMARY

The disclosure, in one respect, relates to content creation and filtering to provide appropriate content to a subscriber. It will be appreciated that the same or similar systems or methods may be utilized for any type of content, any type of subscriber and any type of content distributor.

The present system and method may automate and maintain subscriber profiles based on those subscriber's preferences, behavior and other traits of the subscriber. The system and method may dynamically group individual subscriber profiles into sets called persona groups. Persona groups can be grouped further into subsets called audience groups. This enables content authors/creators to personalize content quickly for thousands of subscribers in a number of persona groups. The content may be accessed in via email or via a website or application (i.e. StreamPage™). These persona groups allow a disassociation between subscribers and content creators.

Content creators or authors may have access to persona groups. Content creators may access the information regarding those persona groups and those content creators may tailor the content based on the persona groups' requests and feedback—associated with what content is “clicked-on” or viewed by a subscriber.

Distributors, or representatives, may be able to regulate content for specific persona groups. A representative may be able to access content and have the content automatically push to persona groups, or may manually pick and choose which content to push to persona groups.

Content can be shared and accessed in strategic methods by subscribers and representatives/distributors. Content can be created to a target audience in a strategic method as well. Each of these methods and systems will be further described herein.

### BRIEF DESCRIPTION OF THE DRAWINGS

In the drawings:

FIG. 1 illustrates a schematic of an embodiment of a processor with an input function, a control unit, memory, a logic unit and an output function;

FIG. 2 illustrates an embodiment of a system and method for creating, distributing, editing and reviewing content;

FIG. 3 illustrates a separate process flow diagram which may be used by the processor of FIG. 1 for creating, editing distributing and reviewing content;

FIG. 4 illustrates a process flow diagram which may be used by the processor of FIG. 1 for content creation and editing; and

FIG. 5 illustrates an alternate process flow diagram which may be used by the processor of FIG. 1 for content distribution.

### DETAILED DESCRIPTION

Referring in general to the accompanying drawings, various embodiments of the present method and system are illustrated to show a system and methods for providing content to subscribers through analysis of subscriber content matching and real time content based analysis. The analysis may then allow personalization of the content subscribed to by a tool that funnels such information to the subscriber, the “Auto-Tailor” personalization engine. The figures illustrate common elements. It should be understood that the figures presented are not meant to be illustrative of actual views of any particular portion of the actual device structure, but are merely schematic representations which are employed to more clearly and fully depict embodiments of the system.

The following provides a more detailed description of ways to implement the present system and method and various representative embodiments thereof. The following description sets forth the proper system and method for means to filter, funnel and tailor content to a user or subscriber in a more effective manner. In various embodiments, methods, devices, systems, and computer-readable media for controlling one or more marketers, company representatives, distributors and subscribers via a computer program are disclosed.

In this description, some drawings may illustrate signals as a single signal for clarity of presentation and description. It will he understood by a person of ordinary skill in the art that the signal may represent a bus of signals, wherein the bus may have a variety of bit widths and the present description may be implemented on any number of data signals including a single data signal.

The system enables markets, or content publishers, to group marketing pages and outreach content stacks, or page bundles, into campaigns which may be called adaptive campaigns. Page bundles may be collections of a page of content (article, event, download, etc.) that can be displayed within a web browser or within a mobile app. Included in the bundle are various outreach templates that control how the page will be promoted via email, social media, text, printed mail, etc. These bundles also include “versions” that enable the system to personalize content for individual subscribers based on persona groups that are built from subscriber profile characteristics.

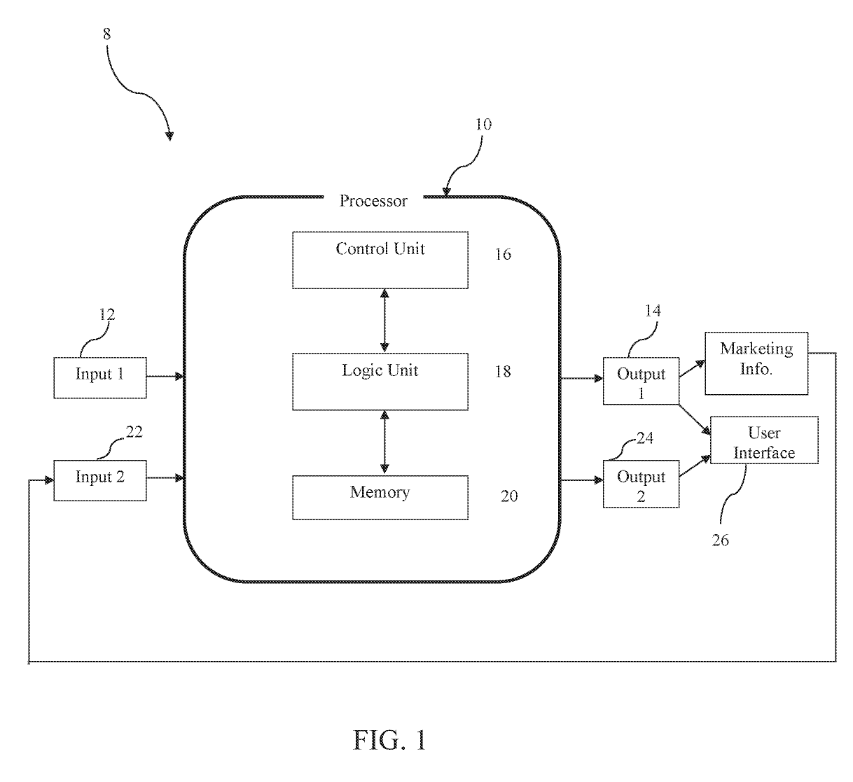

Referring to FIG. 1, a processing system 8 with a processor 10 that may receive an input 12 or inputs and produce an output 14 or outputs. The processor 10 may include control unit 16 that provides actions or signals and may receive actions or signals. The processor 10 may also include a logic unit 18, or plurality of logic units, that may relay signals that may be provided through the control unit to provide a desired result, or output 14. A memory portion 20 of the processor 10 may store information regarding inputs, outputs and the processes of the logic units 18 such that the processor may process the inputs more quickly and efficiently. The memory 20 in the system 8 may store subscriber preferences based on global and sender-based criteria. The input 12 may be a first input that may be a user creating a subscriber profile or a user subscribing to content, content stacks, page bundles or marketing groups and marketing pages and information of content publishers 15. Information can come into the subscriber profile via internal and external database API, interview responses (ongoing), machine learning (both collaborative and content based filtering), mobile apps, and website forms.

The system 8 may process the subscriber information and create an output 14, which may be a first output, to search for and retrieve the information 15 the user subscribed to. The information may be retrieved and a second inputs 22, or series of second inputs, may be processed through the processor 10 and a new series of logic units 18 that may create a second output 24, or series of second outputs that provides the information that the user subscribed to the user or to a user interface 26, which may be a computer, a tablet a smart phone or the like and may be via text, email, social media or similar correspondence.

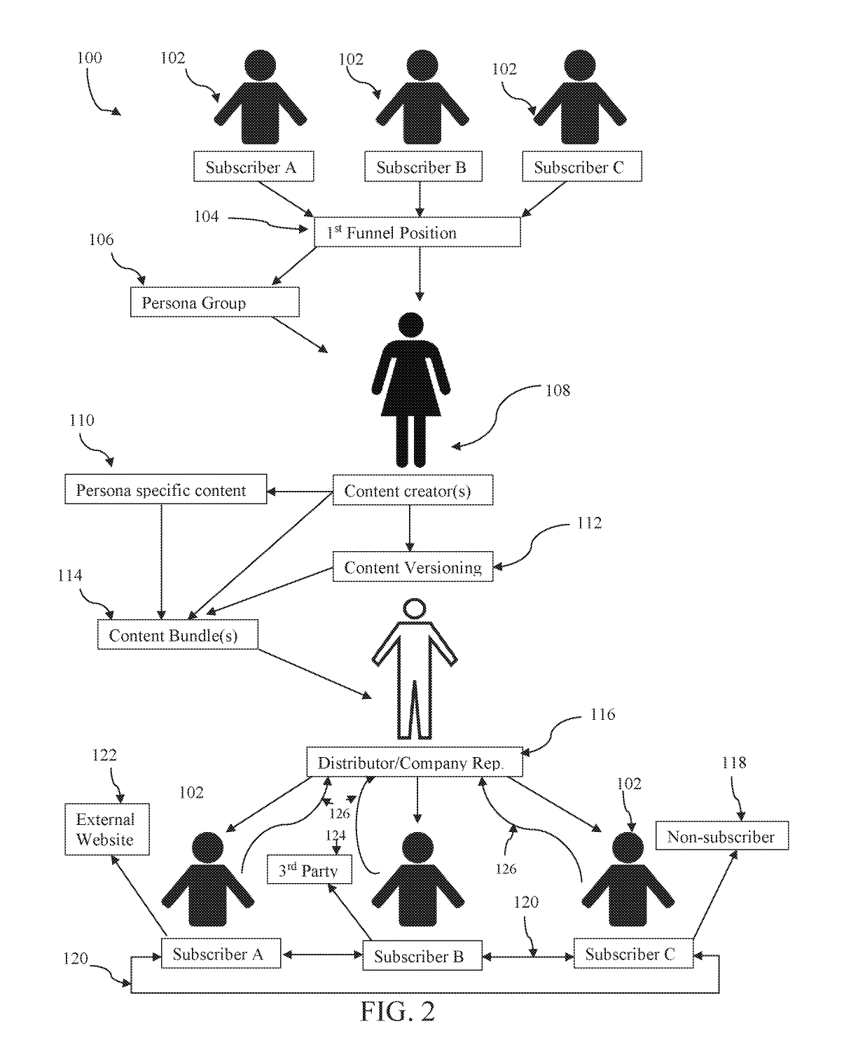

Referring to FIG. 2, a method 100 of use of the system 8, or processing system, is described to provide content to a subscriber 102, which may be multiple subscribers. The method 100 may begin with subscribers 102 able to create a subscriber profile wherein the method 100 utilizes a mix of subscriber-based and sender-based inputs to develop each subscriber profile. Information can come into the system subscribers profile via internal and external database API, interview responses (which may be ongoing), social media, machine learning (both collaborative and content based filtering), mobile apps and website forums. The system and method stores subscriber's preferences based on global and sender based criteria. Global criteria are portable from one sender relationship to another. The method 100 also dynamically updates a funnel position 104 for each subscriber 102 for a variety of sales and retention conversion funnels. A first funnel position 104 which may rely on user/subscriber preferences and behavior.

The method 100 may dynamically group individual subscriber profiles 102 into sets called persona groups 106. Persona groups can be grouped further into subsets called audience groups. This enables content authors/creators 108 to personalize content quickly for thousands of subscribers in a number of persona groups 106. These persona groups 106 allow a disassociation between subscribers 102 and content creators 108. These persona groups 106 may allow for quick reporting of data while protecting individual subscriber's 102 data. The content creator 108 may immediately, or relatively quickly, produce persona specific content 110 based on feedback from subscribers 102 and more specifically persona groups 106. The persona specific content 110 may be produced based on real time feedback to the content creator 108.

Characteristics may make up subscriber profiles. Characteristics can originate in the memory 20 of the processor 10 or be brought in via API from external databases. Characteristics are the foundation for many filters and groupings in the system 8 including audience groups, persona groups, filters, triggers, and kill switches. Characteristics can be global, specific to a market segment, to a publisher or to an individual organization within the system 8.

Furthermore, using content that either attracts or repels subscribers 102 with similar profiles to automatically assign those characteristics to other subscribers 102 with incomplete data sets. For instance, if subscriber A with a complete data set is attracted to content set one and subscriber is also repelled by content set two, then we can use the data set for subscriber A to complete the profile data set for subscriber B who is also attracted to content set one and repelled by content set two, but has an incomplete data set.

The method aids the content author/creator 108 to understand which persona groups106 to focus on the appropriate content for those persona groups106. The method 10 may allow subscribers 102 unlimited content and types of content to access, such as articles, events, alerts, videos, etc. Content versioning 112 may occur after content is created and then new versions are developed or created. “Content versioning” means that different versions of content are created and then bundled for use in the system for tracking, viewing and sharing. Once content reaches a subscriber 102 the version of that content that corresponds to their profile (preferences, history, behaviors) are made visible. The content versioning may be placed into content bundles 114 which may be comprised of multiple content creations from the content creator 108, from multiple content versions 112 or from multiple persona specific content 110. The content bundle 114 may be made up of single content creations, content versions or persona specific content as well.

A representative 116 may access content but only content bundles and not individual versions of content 112. A representative 116 may manage subscriber's content and may automatically push content or manually pick and choose which content to push to subscribers 102. The representative 116 may have access to all the content which may reside on a single content cloud. The representative 116 may request access to various publishers of content or of content of the authors/creators 108. A publisher or author/creator 108 may have the option to automatically or manually authorize either internal or external representatives to access and share their content.

The method 100 may automatically personalize content and the sender-subscriber relationship for each recipient. The method 100 may also drive traffic to external websites 118 or other online properties. The system and method 100 may enable subscribers 102 to share 120 the content they receive with other subscribers 102. However, content may also be shared with non-subscribers 122, third parties 124 other websites 118, as previously disclosed. Content versioning and subscribers interviews may help in managing personalization for those non-subscribers. Sharing of content may be performed through the system itself or may be shared via other methods including, but not limited to social media outlets (i.e. Facebook, Instagram, Twitter, etc.), direct mail, e-mail, text, or other means including electronic means.

Subscribers 102 may engage 126 with the content and representatives through the system. Subscribers have the ability to request content, send and receive messages, read and share content and many other interactions.

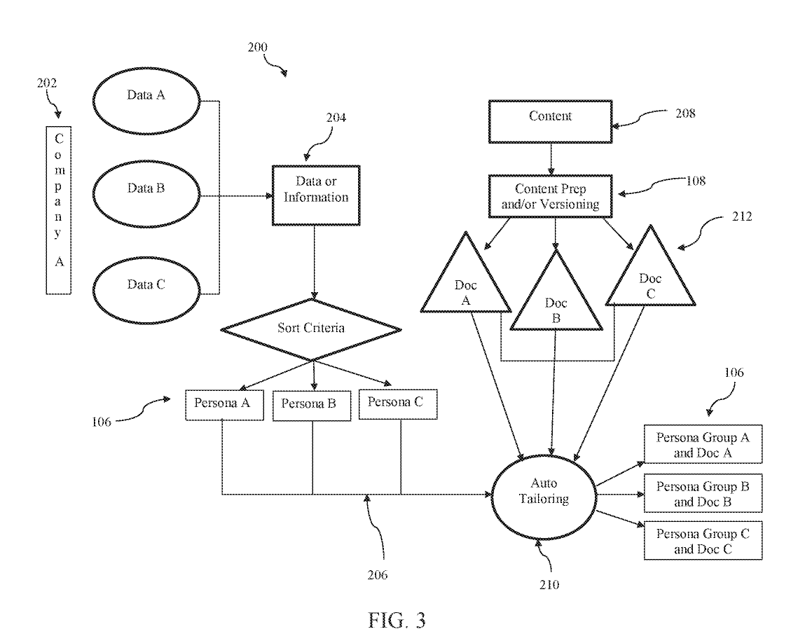

Referring to FIG. 3, a separate method 200 of providing content to subscribers 102 is illustrated. A company 202, which may be a plurality of companies or a single company, provide information 204, or data, to the system 8 describing what content the customer 102 desires. The information may be customer lists, email lists, customer sign-ups and each with preferences and the like. Utilizing the profile information the system 8, takes the information provided by the users and based on the profile information creates the persona groups 106 as previously described. The persona groups 106 are cross-referenced 206, or cross-checked, against the content 208 via auto-tailoring 210. The system 8 gathers the content 208 which may be customized 208 by an author/creator 108 (which may be similar to the persona specific content creation 110). The content 208 may be versioned by the creator into separate content specific documents 212. The content specific document(s) 212 is/are then pushed to the persona groups 106 providing subscriber 102 requested and desired content that may be easily reviewed and shared. The customer information 204 and the content 208 are auto-tailored 210, meaning the subscriber requests, company provided information and content are funneled together through the system 8 and then appropriately pushed the appropriate persona groups 106.

One element of the system 8 may enable markets to group marketing pages and outreach content stacks, or page bungles, into campaigns which may be called adaptive campaigns. One logic sequence may be carried out through the system 8 via the processor 10. A user, or subscriber 102, sets up a profile or has a profile set up for him/her through the company information (See FIG. 3) that is input 12 into the processor 10 that is stored in the memory 20. A content creator 108 provides content to the system 8 that is input 2 into the processor 10 and is stored in the memory 20.

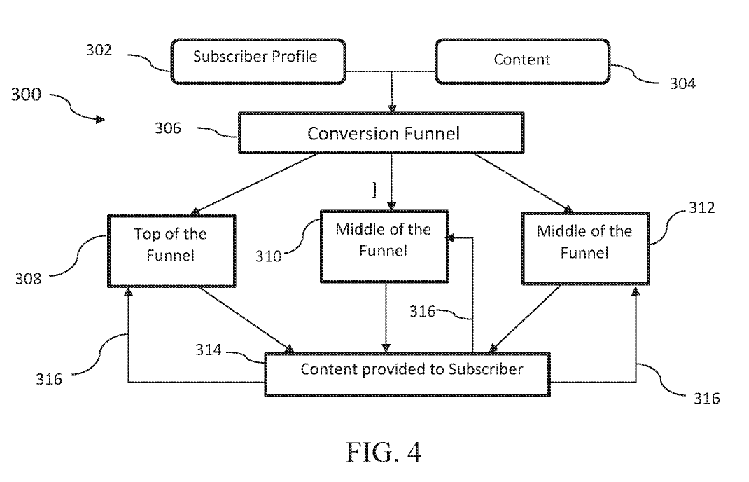

Referring to FIG. 4, one logic sequence (300) for adaptive campaigns includes pairing the subscriber's profile (302) with content (304) from a content creator 108 (see FIG. 3). A specific subscriber profile or new content may trigger the one logic sequence (300). The information, from the subscriber and the content, collects into page bundles which collect into buckets of content for each stage of a conversion funnel (306). The conversion funnel may include a top of the funnel (308), a middle of the funnel (310) or a bottom of the funnel (312) depending on subscriber's preferences. The content is then pushed to the subscriber (314). The content may be moved at alternate frequencies and even at different funnel stages depending on subscriber preferences. Content creators 108 provide content into the system 8 at a frequency as requested and required. Subscriber preferences will continue to trigger content to be sent to the subscriber until a “stop” or “kill switch” (316) is achieved. Data itself may produce a trigger to stop of the content being provided to a subscriber 102. External data may be input 12, 22 into the processor 10 just like a subscriber profile, or content creator data. The campaign may include a call to action that may be the conversion goal of the campaign. Calls to action are persistent at each stage of the conversion funnel (306) enabling the subscriber 102 to progress as fast or as slow as they like.

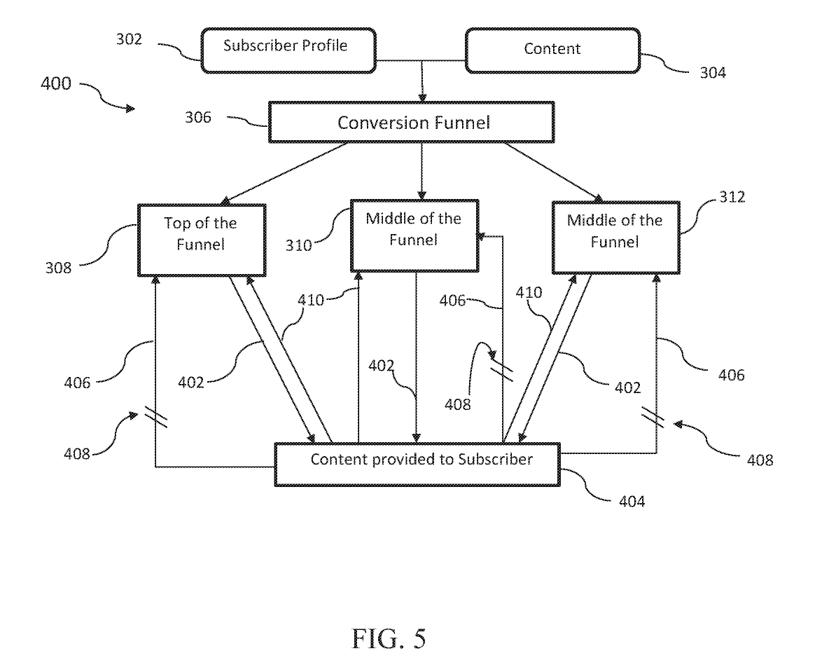

Alternatively, the system 8 may utilize the subscriber 102 preferences, as well as company representatives or distributors 116, to protect subscribers 102 from too much information, or, more importantly, too much irrelevant information meaning “fatigue prevention.” Referring to FIG. 5, an alternate logic sequence 400 may include the factors similarly described previously. The sequence 400 develops a cadence (402) for contact, which may be via text, email or the like for each subscriber. Furthermore, frequency and timing of the contact is adjusted for each subscriber 102. For example, the push of content (404) may only loop (406) on itself a certain number of times to retrieve content from the memory 20 of the system 8. As another alternative a subscriber 102 may enter a “snooze” (408) command to the system 8 that may limit the number of updates from the system to the subscriber 102. The limits may be timing, for example, monthly updates provided instead of daily or weekly updates. Alternatively, the snooze may discontinue sending of content until subscriber provides notice to continue receiving content (410).

The system 8 is intended to ask, create, share and engage with subscribers 102. Asking subscribers 102 what they want, creating content for those subscribers102, sharing the content with the subscribers 102 and engaging with those subscribers102. The system 8may be a repository of marketing tools made available to subscribers and marketers that they may then browse and add to their own library of tools. The content may include blogs, articles, podcasts, music, videos, etc. The content creators or publishers may be uploading content to the system to drive the marketers and ultimately the subscribers (i.e. consumers) to the publishers. The publishers ultimately may control what content is provided but can easily “just hit send” and the content is available. The publishers and marketers may have access to the list of click rates and list of subscribers as well. Publishers may also have access to segment data from the reader to the marketer to the publisher.

As a summary, the system commences by gathering data about subscribers to create a subscriber profile. This data is gathered through integrating with existing sources such as CRMs, purchase history databases, and through a proprietary interview process. The system combines this data into digestible reports that marketers may use to create personalized content for specific persona groups. The system automatically creates persona groups and populates them with reported stats. Content creators may create a master content item and use the persona groups to version that content quickly. This maker content item and its associated versions are bundled together in the system to create a content bundle. The content bundle can be prepped for a variety of distribution channels like email, Web, social media, postcards, etc. An innumerable set of content bundles may be created from the mass of data collected. These content bundles are then published to a content cloud. The content cloud is a repository of content bundles ready for distribution. Account representatives may browse and search the content cloud and then add/edit/share content with their existing subscribers without having to take the content out of the system and send in a different format through other social media, email, text, etc. Some content bundles may be shared through representatives to subscribers automatically. Some content may be pushed to social media automatically. “Auto-tailor” is a method of communication between the subscriber profile database and the content cloud to match the right version of content to the right subscriber. This creates personalization instantaneously and immediately and is continually updating. Marketers may create content for specific persona groups and marketers can do this quickly and update immediately. Subscribers are constantly updating their profiles through behavior and answering occasional interview questions. Subscribers may interact with representatives through the system. Subscriber behavior is reported back to representatives through “opportunity reports.” These opportunity reports tell representatives who they should contact, or who may be ready to make a purchase, which is not engaging through the system and may need offline contact. Subscriber activity may be summarized and sent back to marketers who use the information to improve their messages to specific persona groups.

Although the foregoing disclosure provides many specifics, these should not be construed as limiting the scope any of the ensuing claims. Other embodiments may be devised which do not depart from the scopes of the claims. Features from different embodiments may be employed separately or in combination. Accordingly, all additions, deletions and modifications to the disclosed subject matter that fall within the scopes of the claims are to be embraced thereby. The scope of each claim is indicated and limited only by its plain language and the full scope of available legal equivalents to its elements.

What is claimed:

1. A system for content based filtering, the system comprising:
a processor programmed with predetermined logic sequences for providing content to a subscriber the processor configured to:
receive an input signal from a subscriber creating at least one subscriber profile;
receive an input signal from a content creator creating at least one piece of content for a subscriber;
signal a control unit within the processor to produce at least one output to a subscriber based on the subscriber profile and the at least one piece of content; and
signal the subscriber regarding the content to a subscriber interface.

2. The system of claim 1, wherein the at least one output comprises a plurality of outputs to a plurality of marketing sources.

3. The system of claim 1, wherein the at least one subscriber profile comprises a plurality of subscriber profiles wherein the processor is configured to:
group the plurality of subscriber profiles into persona groups based on subscriber inputs; and
further group the plurality of subscribers based on attracted and repelled content provided by content creators.

4. The system of claim 1, wherein the at least one piece of content comprises a plurality of content wherein the processor further provides cross-referencing of content against a group based persona.

5. The system of claim 4, wherein the system provides an output based on the group based persona and the plurality of content to a group of subscribers.

6. The system of claim 4, wherein the system provides an output based on the group based persona and the plurality of content to a subscriber.

7. The system of claim 4, wherein a content creator produces additional inputs of content to the processor based on the group based persona feedback.

8. The system of claim 4, wherein a content creator produces additional inputs of content o the processor based on the subscriber feedback.

9. A system for providing increasing content based interactions the system comprising:
a processor with a memory, a logic unit and a control unit the processor programmed with predetermined logic sequences for providing content to a subscriber the processor configured to:
receive a first input from a company regarding a subscriber's preferences to create a subscriber profile;
receive a second input from a content creator regarding a content intended for subscribers:
cross-reference the content and the subscriber's preferences;
signal the control unit to provide content to the subscriber based on the cross-reference.

10. The system of claim 9, wherein the first input comprises a plurality of first inputs and the second input comprises a plurality of second inputs.

11. The system of claim 10, wherein the plurality of first inputs comprises: company or customer lists, company email lists, company or customer sign-ups, and company or customer surveys.

12. The system of claim 9, wherein the at least one subscriber profile comprises a plurality of subscriber profiles wherein the processor is configured to:
group the plurality of subscriber profiles into persona groups based on company inputs.

13. The system of claim 12, wherein the system provides an output based on the group based persona and the plurality of content to a group of subscribers.

14. The system of claim 12, wherein the system provides an output based on the group based persona and the plurality of content to a subscriber.

15. The system of claim 12, wherein a content creator produces additional inputs of content to the processor based on the group based persona feedback.

16. The system of claim 12, wherein a content creator produces additional inputs of content to the processor based on the subscriber feedback.

17. A system for providing content based information to a subscriber the system comprising:
at least one processor programmed with predetermined logic sequences for providing content to a subscriber, the processor configured:
receive an input signal from at least one subscriber creating at least one subscriber profile with subscriber preferences;
signal a control unit within the processor to produce at least one output to a third party based on the subscriber profile;
receive a second input of at least one content based on the at least one output of a subscriber's preferences; and
signal the subscriber regarding the content to a subscriber interface.

18. The system of claim 17, wherein the at least on subscriber comprises a plurality of subscribers and the system processor groups the plurality of subscribers into group based personas.

19. The system of claim 16, wherein a content creator produces additional inputs of content to the processor.

20. The system of claim 19, wherein the system provides an output based on the group based persona and the plurality of content to a subscriber.
